(19) United States
(12) Patent Application Publication
(10) Pub. No.: US 2017/0140179 A1
(43) Pub. Date: May 18, 2017

(54) MAGNETIC CARD READER WITH ELECTROSTATIC DISCHARGE STRIP

(71) Applicant: VERIFONE, INC., San Jose, CA (US)

(72) Inventors: Richard Hee Hock NEO, Singapore (SG); Thai Wee ANG, Singapore (SG); Kian Tiong YEO, Singapore (SG)

(73) Assignee: VERIFONE, INC., San Jose, CA (US)

(21) Appl. No.: 14/943,380

(22) Filed: Nov. 17, 2015

(51) Int. Cl. G06K 7/08; G06K 7/00

(52) U.S. Cl. CPC G06K 7/084; G06K 7/0008

(57) ABSTRACT

A slidable magnetic card reader particularly suitable for magnetic payment cards having at least one longitudinal edge surface, the card reader including a magnetic card reading head operative to provide a data output in response to sliding thereby of a magnetic card bearing readable magnetically encoded data and a sliding track defining assembly including an elongate magnetic card edge engagement surface arranged for sliding engagement with a longitudinal edge surface of a magnetic card, the elongate magnetic card edge engagement surface extending at least to a location generally underlying the magnetic card reading head, at least a portion of the elongate magnetic card edge engagement surface being electrically conductive and being coupled to electrical ground.

### FIELD OF THE INVENTION

The present invention relates to magnetic card readers generally.

### BACKGROUND OF THE INVENTION

Various types of magnetic card readers are known.

### SUMMARY OF THE INVENTION

The present invention seeks to provide an improved magnetic card reader which is suitable for use with conductive cards bearing magnetic stripes.

There is thus provided in accordance with a preferred embodiment of the present invention a slidable magnetic card reader particularly suitable for magnetic payment cards having at least one longitudinal edge surface, the card reader including a magnetic card reading head operative to provide a data output in response to sliding thereby of a magnetic card bearing readable magnetically encoded data and a sliding track defining assembly including an elongate magnetic card edge engagement surface arranged for sliding engagement with a longitudinal edge surface of a magnetic card, the elongate magnetic card edge engagement surface extending at least to a location generally underlying the magnetic card reading head, at least a portion of the elongate magnetic card edge engagement surface being electrically conductive and being coupled to electrical ground.

Preferably, the elongate magnetic card edge engagement surface extends to two opposite sides of the location underlying the magnetic card reading head and at least a portion of the elongate magnetic card edge engagement surface on each of the two opposite sides of the location underlying the magnetic card reading head is electrically conductive and is coupled to electrical ground.

In accordance with a preferred embodiment of the present invention the elongate magnetic card edge engagement surface is electrically conductive substantially along its entire length. Preferably, the sliding track defining assembly is electrically conductive.

In accordance with a preferred embodiment of the present invention the elongate magnetic card edge engagement surface includes an electrically conductive strip. Additionally, the electrically conductive strip is die cut from a metal sheet. Alternatively, the electrically conductive strip is die cast.

Preferably, the elongate magnetic card edge engagement surface includes an electrically non-conductive strip including at least two cutouts and an electrically conductive strip including at least two protrusions which resiliently extend through the at least two cutouts.

### BRIEF DESCRIPTION OF THE DRAWINGS

The present invention will be understood and appreciated more fully from the following detailed description, taken in conjunction with the drawings in which:

FIGS. 1A and 1B are simplified pictorial assembled and exploded view illustrations of a point of sale device constructed and operative in accordance with one preferred embodiment of the present invention;

FIGS. 2A and 2B are simplified perspective illustrations of a magnetic card reader assembly forming part of the point of sale device of FIGS. 1A and 1B;

FIGS. 3A and 3B are simplified exploded view illustrations of the magnetic card reader assembly of FIGS. 2A and 2B;

FIGS. 4A and 4B are simplified pictorial assembled and exploded view illustrations of a point of sale device constructed and operative in accordance with another preferred embodiment of the present invention;

FIGS. 5A and 5B are simplified perspective illustrations of a magnetic card reader assembly forming part of the point of sale device of FIGS. 4A and 4B;

FIGS. 6A and 6B are simplified exploded view illustrations of the magnetic card reader assembly of FIGS. 5A and 5B;

FIGS. 7A and 7B are simplified pictorial assembled and exploded view illustrations of a point of sale device constructed and operative in accordance with a further preferred embodiment of the present invention;

FIGS. 8A and 8B are simplified perspective illustrations of a magnetic card reader assembly forming part of the point of sale device of FIGS. 7A and 7B; and

FIGS. 9A and 9B are simplified exploded view illustrations of the magnetic card reader assembly of FIGS. 8A and 8B.

### DETAILED DESCRIPTION OF PREFERRED EMBODIMENTS

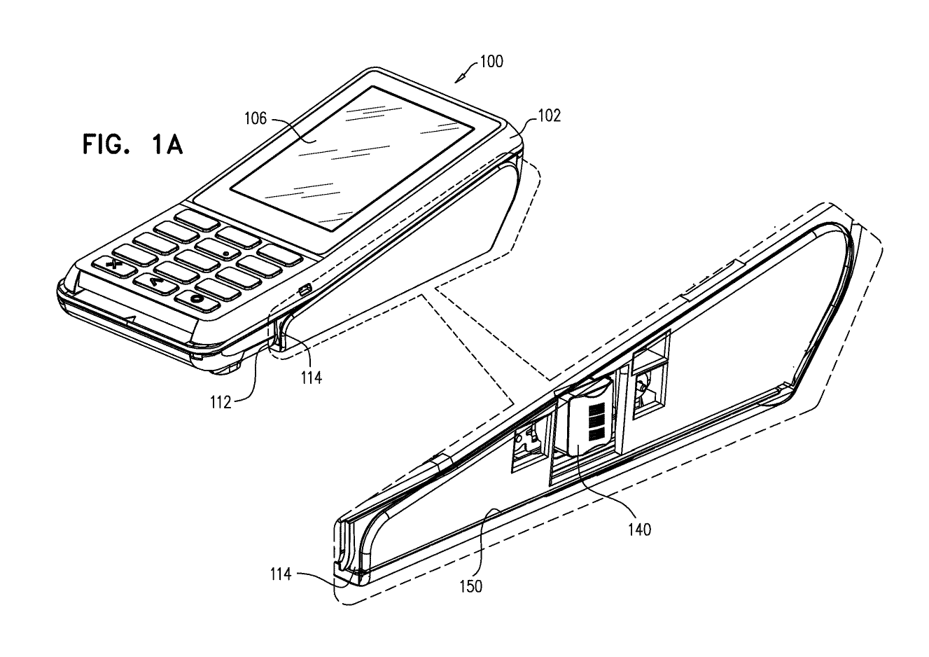

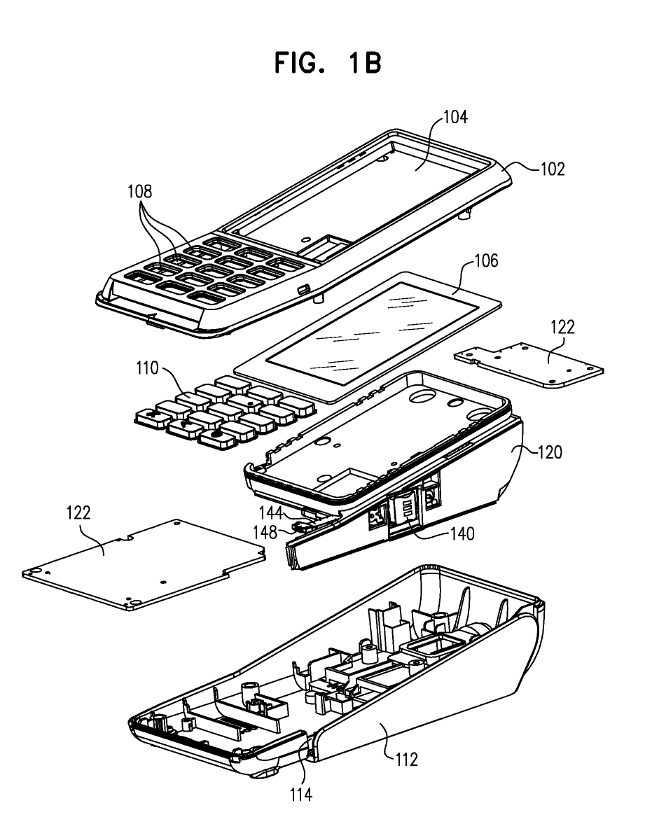

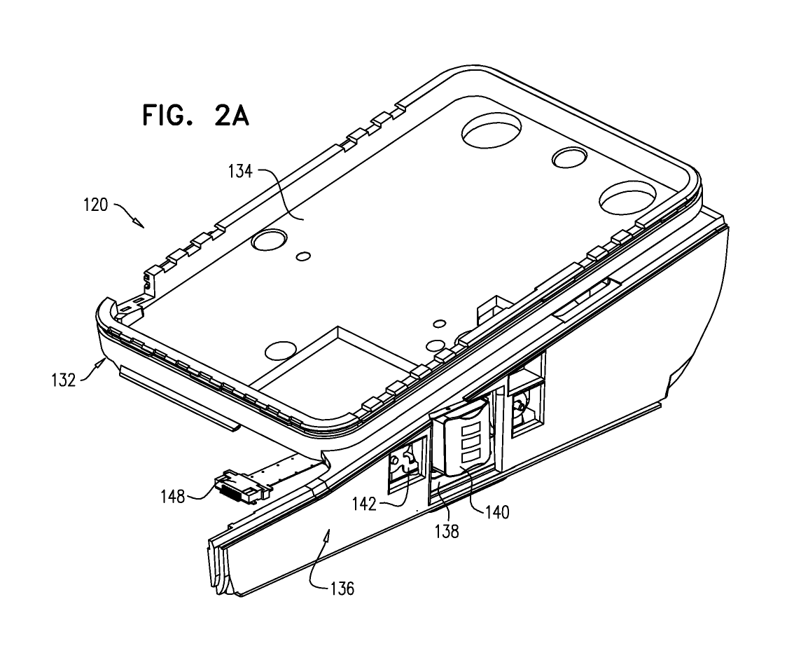

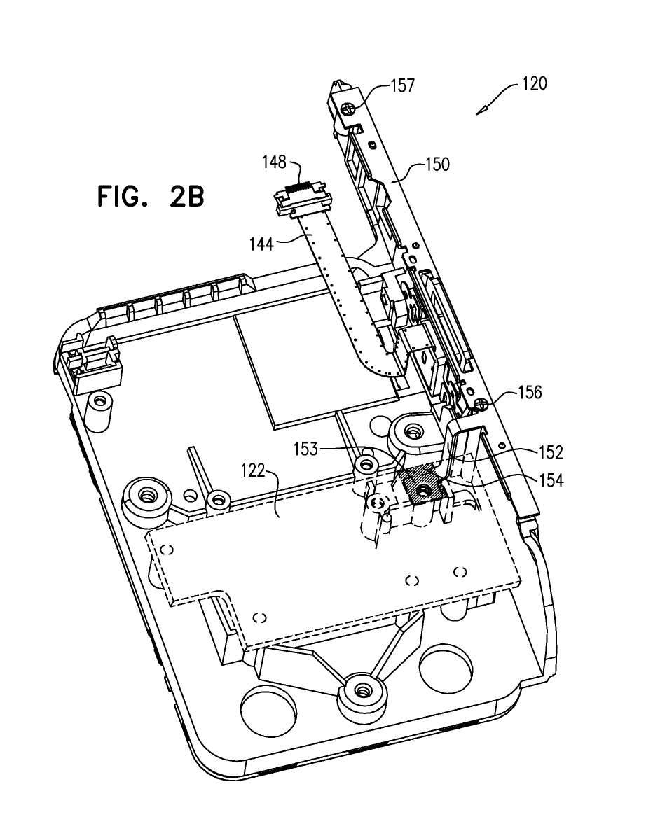

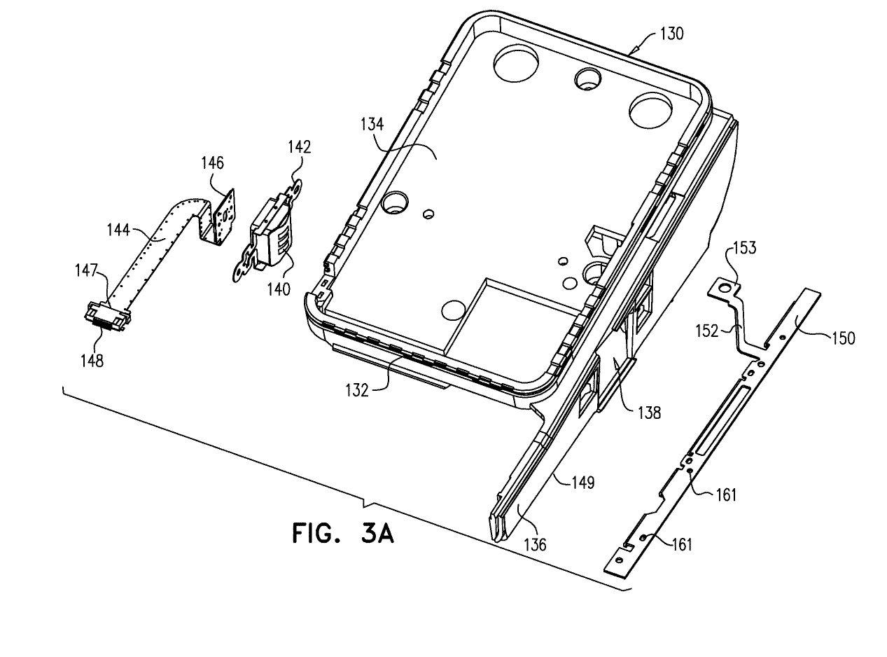

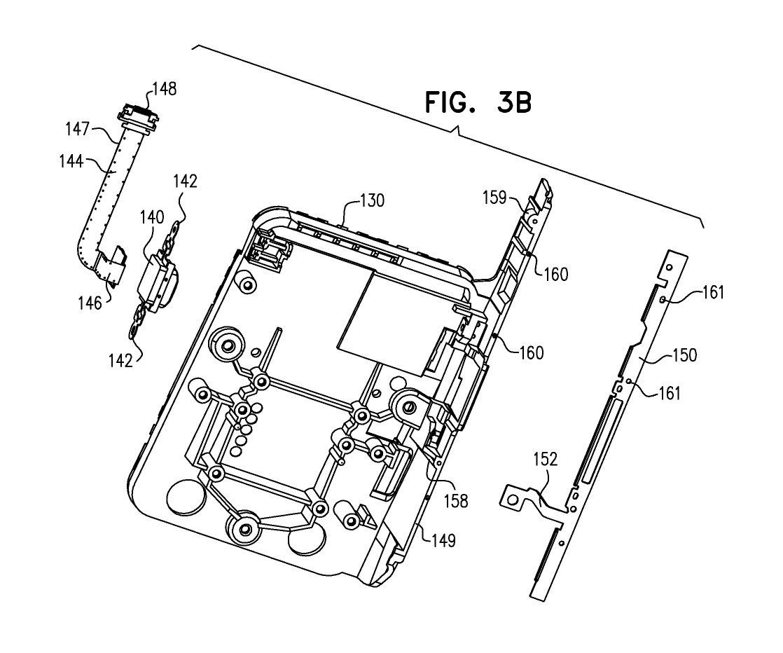

Reference is now made to FIGS. 1A and 1B, which are simplified pictorial assembled and exploded view illustrations of a point of sale device constructed and operative in accordance with one preferred embodiment of the present invention, to FIGS. 2A and 2B, which are simplified perspective illustrations of a magnetic card reader assembly forming part of the point of sale device of FIGS. 1A and 1B, and to FIGS. 3A and 3B, which are simplified exploded view illustrations of the magnetic card reader assembly of FIGS. 2A and 2B.

As seen in FIGS. 1A and 1B, there is provided a point of sale device 100, preferably including a top housing portion 102 having a first aperture 104 for accommodating a display screen 106 and an array of key openings 108 for accommodating keys of a keypad portion 110. A bottom housing portion 112 cooperates with top housing portion 102 and defines a magnetic card swipe slot 114.

Top housing portion 102 and bottom housing portion 112 together enclose a magnetic card reader assembly 120 and typically two PCBs 122, onto which are mounted electrical circuitry for operating the point of sale device 100.

Turning now to FIGS. 2A-3B, it is seen that the magnetic card reader assembly 120 includes a base member 130, preferably injection molded of plastic and including a screen support portion 132 defining a screen support surface 134 and, extending generally perpendicular thereto, a magnetic stripe reader head support portion 136. Magnetic stripe reader head support portion 136 includes an aperture 138 through which extends a magnetic stripe reader head 140, which may be of conventional construction and which is resiliently mounted onto magnetic stripe reader head support portion 136 by means of a spring support 142, ends of which are mounted onto magnetic stripe reader head support portion 136. A flexible connector 144 is coupled at one end 146 thereof to the magnetic stripe reader head 140 and at opposite end 147 thereof to a data connector 148.

A bottom facing edge 149 of magnetic stripe reader head support portion 136 defines a mounting surface for an elongate magnetic card edge engagement surface defining electrically conductive strip 150, preferably die cut from a metal sheet, which extends transversely outwardly towards bottom housing portion 112 and thus preferably defines a floor of magnetic card swipe slot 114 with which floor the edge of a magnetic card (not shown) is in engagement as it is swiped through slot 114.

Strip 150 is operative to provide electrostatic discharge from a magnetic card, such as a metal card, a metal coated card or a card having an electrically conductive bottom edge, swiped therealong in either direction and in engagement therewith to ground, preferably via a ground connection portion 152 thereof, which is connected, at an end 153 thereof, to a grounded terminal 154 formed on one of PCBs 122. The electrical discharge of the card occurs at least prior to engagement of the card with the magnetic strip reader head 140. Grounded terminal 154 is preferably coupled to ground via electrical circuitry on PCB 122.

Strip 150 is preferably secured to bottom facing edge 149 of magnetic stripe reader head support portion 136 by means of a pair of screws 156 and 157, which threadably engage respective suitably apertured bosses 158 and 159. Precise positioning of strip 150 onto bottom facing edge 149 is preferably enhanced by the provision of locator protrusions 160 on bottom facing edge 149, which engage corresponding apertures 161 on strip 150.

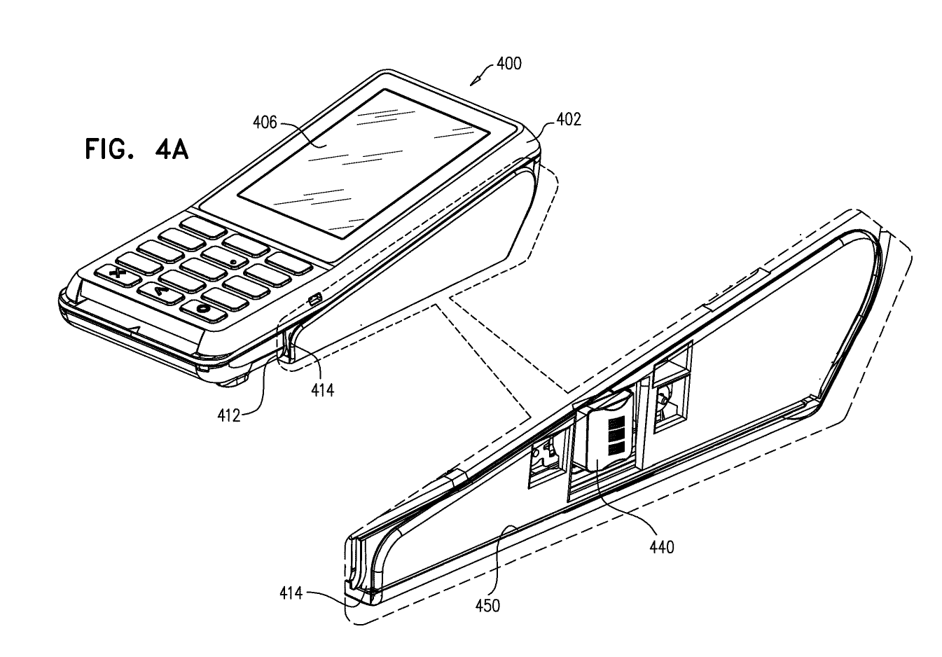

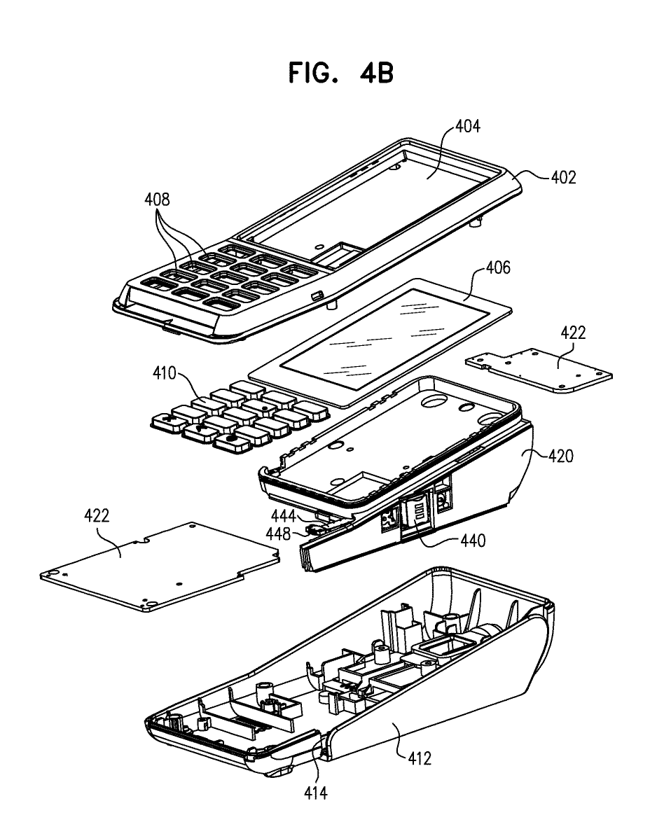

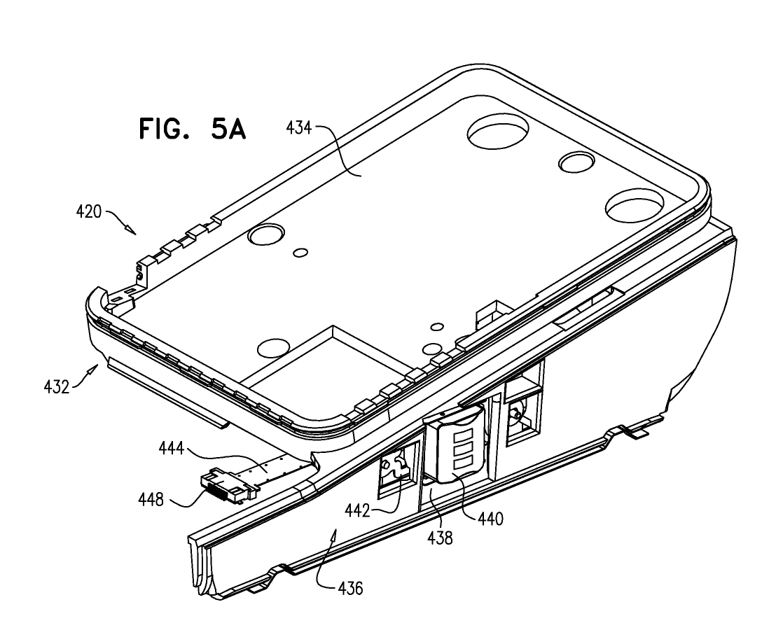

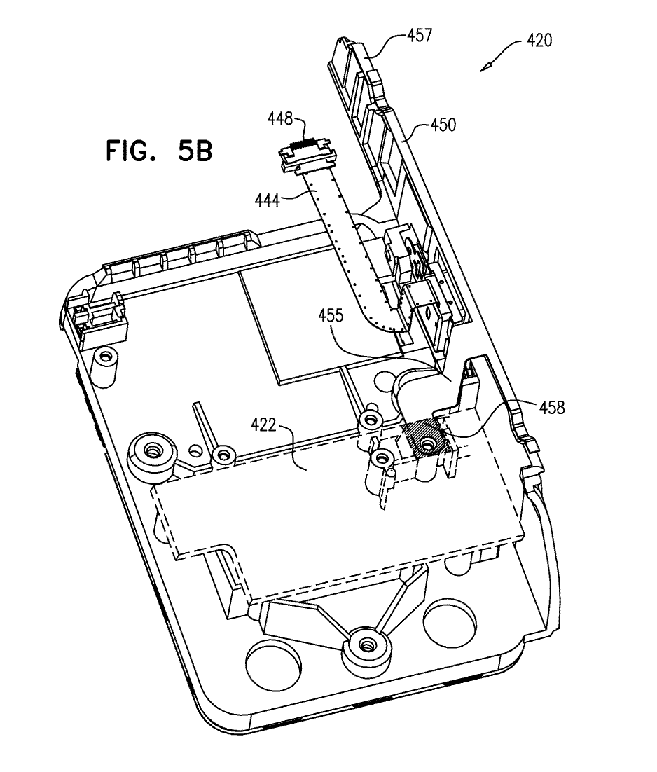

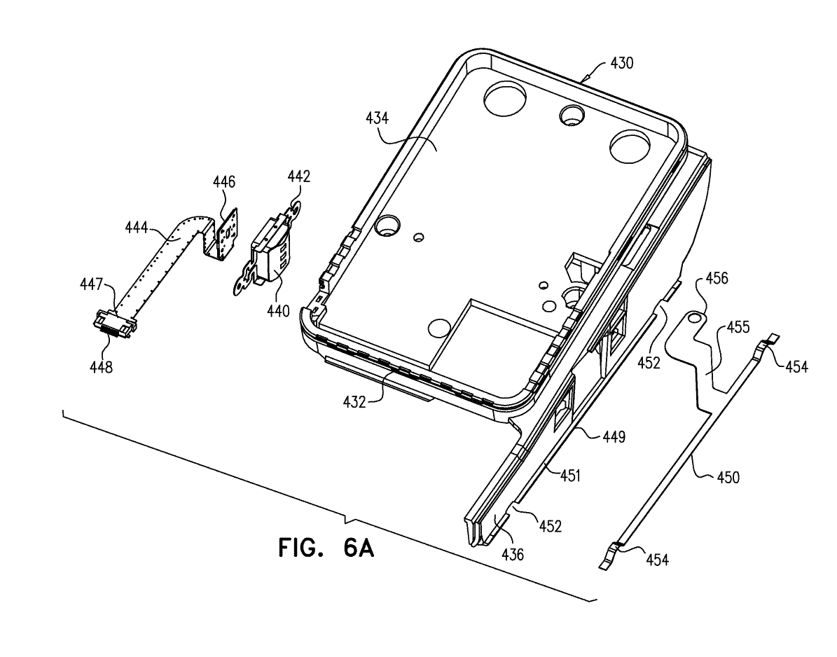

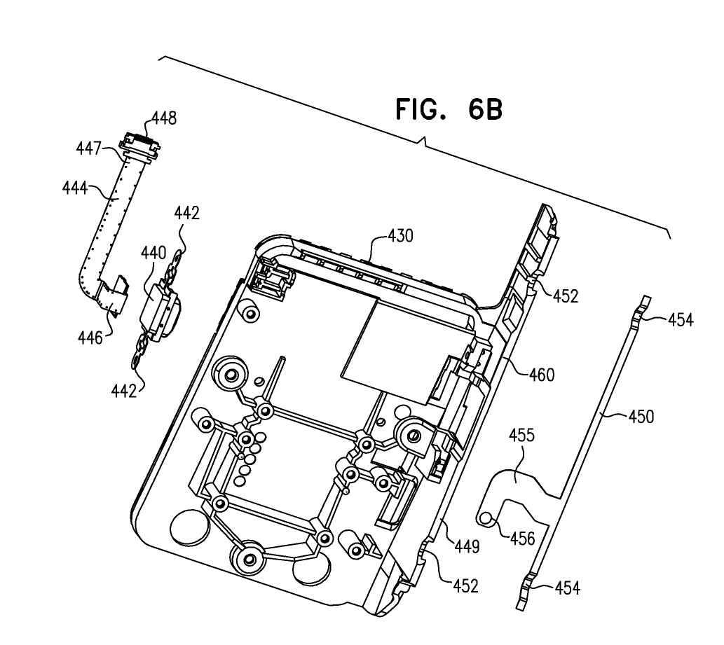

Reference is now made to FIGS. 4A and 4B, which are simplified pictorial assembled and exploded view illustrations of a point of sale device constructed and operative in accordance with one preferred embodiment of the present invention, to FIGS. 5A and 5B, which are simplified perspective illustrations of a magnetic card reader assembly forming part of the point of sale device of FIGS. 4A and 4B, and to FIGS. 6A and 6B, which are simplified exploded view illustrations of the magnetic card reader assembly of FIGS. 5A and 5B.

As seen in FIGS. 4A and 4B, there is provided a point of sale device 400 preferably including a top housing portion 402 having a first aperture 404 for accommodating a display screen 406 and an array of key openings 408 for accommodating keys of a keypad portion 410. A bottom housing portion 412 cooperates with top housing portion 402 and defines a magnetic card swipe slot 414.

Top housing portion 402 and bottom housing portion 412 together enclose a magnetic card reader assembly 420 and typically two PCBs 422, onto which are mounted electrical circuitry for operating the point of sale device 400.

Turning now to FIGS. 4A-6B, it is seen that the magnetic card reader assembly 420 includes a base member 430, preferably injection molded of plastic and including a screen support portion 432 defining a screen support surface 434 and, extending generally perpendicular thereto, a magnetic stripe reader head support portion 436. Magnetic stripe reader head support portion 436 includes an aperture 438 through which extends a magnetic stripe reader head 440, which may be of conventional construction and which is resiliently mounted onto magnetic stripe reader head support portion 436 by means of a spring support 442, ends of which are mounted onto magnetic stripe reader head support portion 436. A flexible connector 444 is coupled at one end 446 thereof to the magnetic stripe reader head 440 and at opposite end 447 thereof to a data connector 448.

A bottom facing edge 449 of magnetic stripe reader head support portion 436 extends outwardly towards bottom housing portion 412 and defines a mounting surface for an elongate magnetic card edge engagement protrusion defining electrically conductive strip 450, preferably die cut from a metal sheet, which extends transversely outwardly towards bottom housing portion 412.

An upward facing surface 451 of bottom facing edge 449 preferably defines a floor of magnetic card swipe slot 414 with which floor the edge of a magnetic card (not shown) is in engagement as it is swiped through slot 414. Bottom facing edge 449 is formed with at least two cut outs 452 through which resiliently extend corresponding protrusions 454 preferably formed by folding of strip 450. Protrusions 454 are preferably positioned on both sides of the magnetic stripe reader head 440 along magnetic card swipe slot 414 in order to resiliently and yieldingly engage an edge of a card swiped along slot 414 in either direction prior to engagement of the card with magnetic stripe reader head 440. The electrical discharge of the card occurs at least prior to engagement of the card with the magnetic strip reader head 440.

Strip 450 is operative to provide electrostatic discharge from a magnetic card, such as a metal card, a metal coated card or a card having an electrically conductive bottom edge, swiped therealong in either direction and in engagement therewith to ground, preferably via a ground connection portion 455 thereof, which is connected, at an end 456 thereof, to a grounded terminal 458 formed on one of PCBs 422. Grounded terminal 458 is preferably coupled to ground via electrical circuitry on PCB 422.

Strip 450 is preferably resiliently secured to bottom facing edge 449 of magnetic stripe reader head support portion 436 by means of a pair of screws (not shown), which threadably engage respective suitably apertured bosses (not shown). Alternatively, strip 450 may be resiliently secured to bottom facing edge 449 by any suitable attachment method, such as by use of an adhesive.

Precise positioning of strip 450 onto bottom facing edge 449 may be enhanced by the provision of locator protrusions (not shown) on bottom facing edge 449, which engage corresponding apertures (not shown) on strip 450.

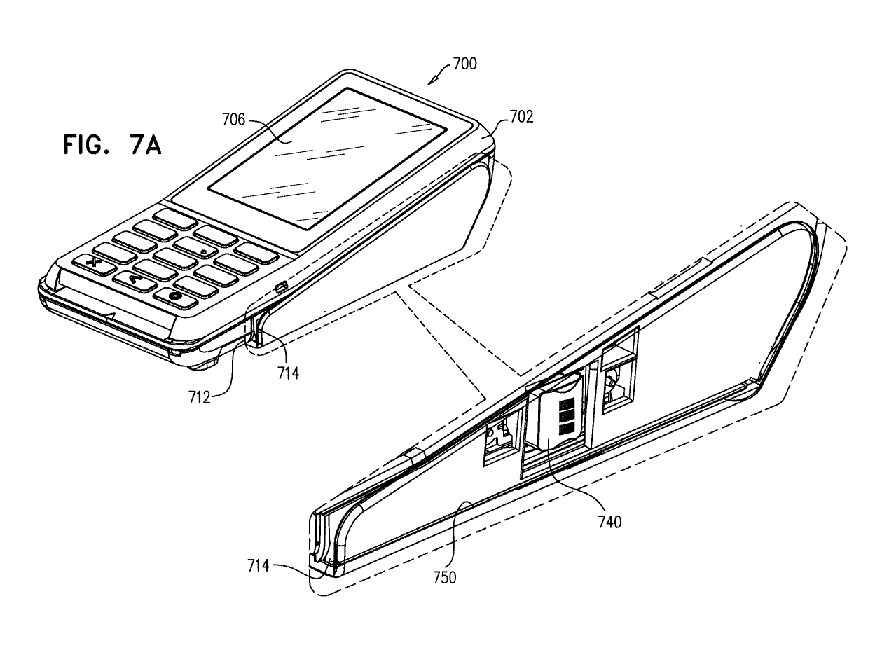

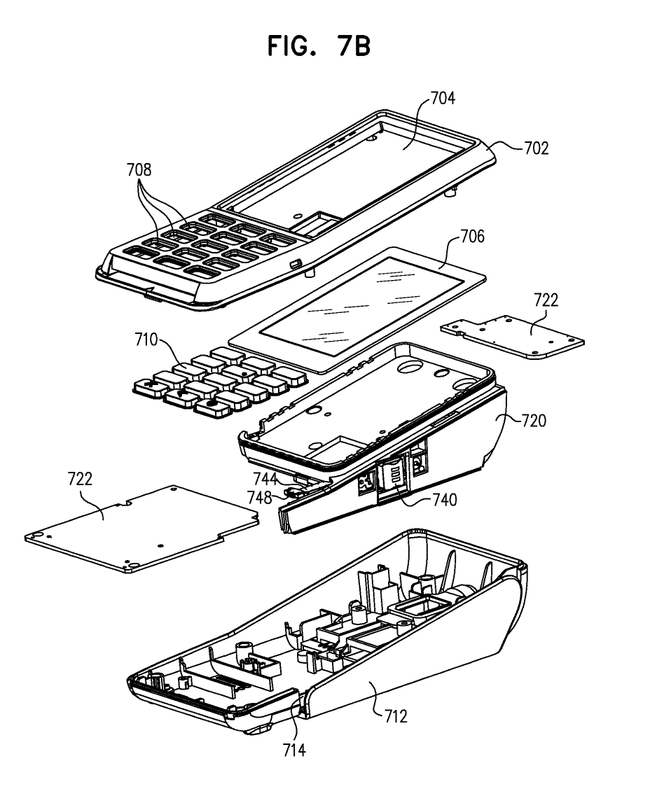

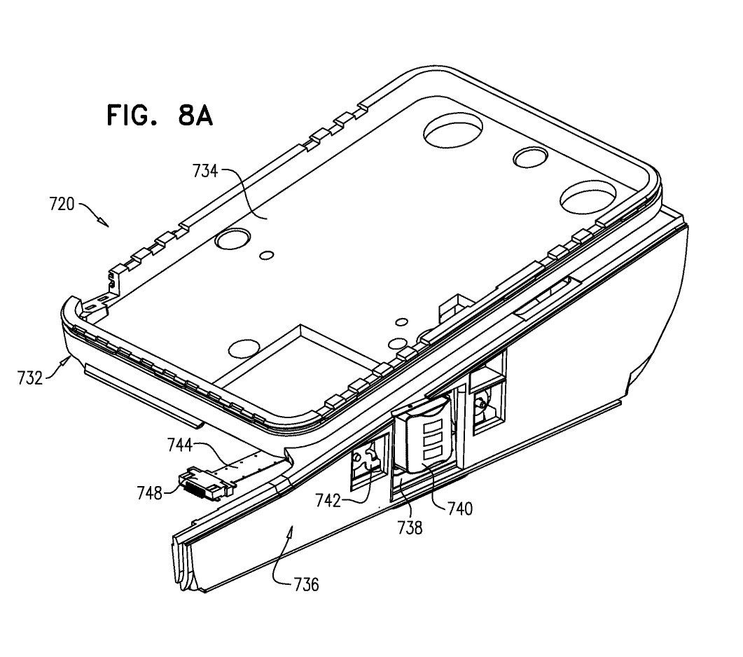

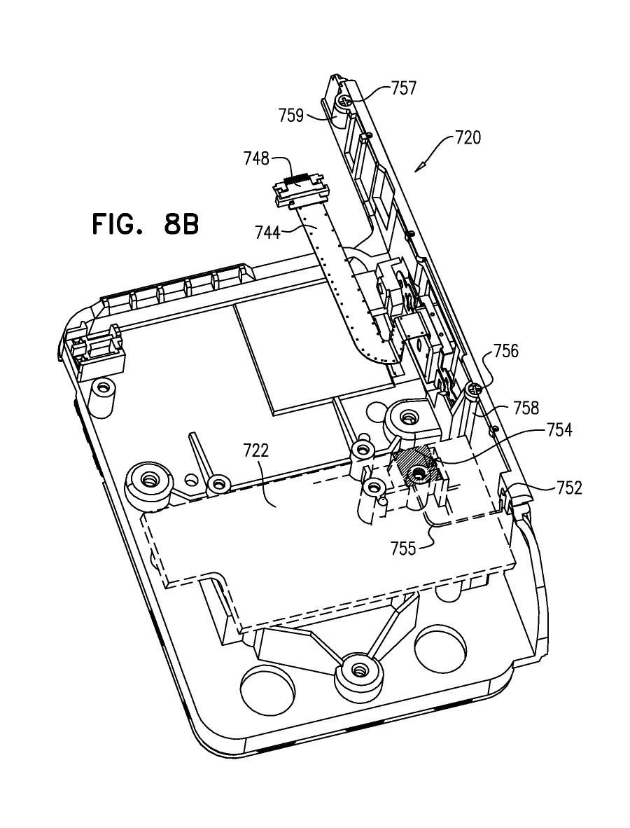

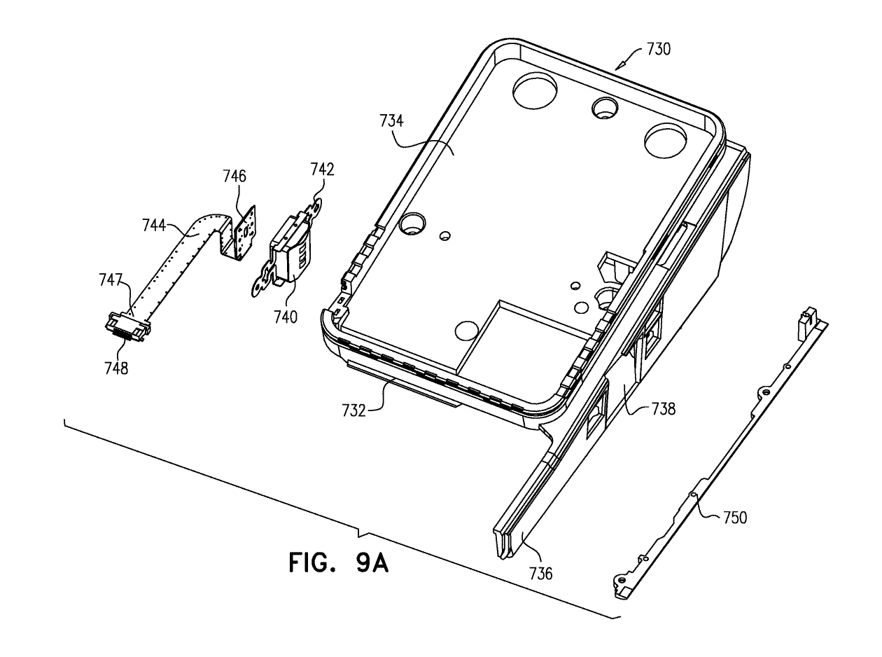

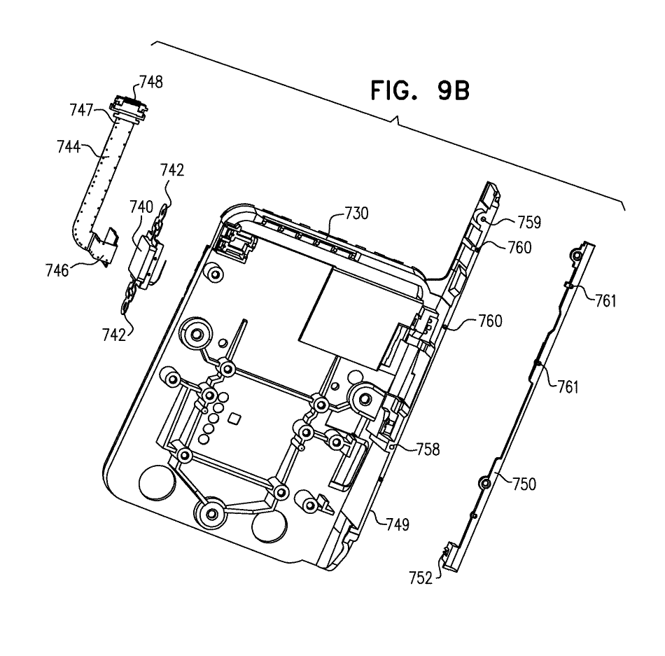

Reference is now made to FIGS. 7A and 7B, which are simplified pictorial assembled and exploded view illustrations of a point of sale device constructed and operative in accordance with one preferred embodiment of the present invention, to FIGS. 8A and 8B, which are simplified perspective illustrations of a magnetic card reader assembly forming part of the point of sale device of FIGS. 7A and 7B, and to FIGS. 9A and 9B, which are simplified exploded view illustrations of the magnetic card reader assembly of FIGS. 8A and 8B.

As seen in FIGS. 7A and 7B, there is provided a point of sale device 700 preferably including a top housing portion 702 having a first aperture 704 for accommodating a display screen 706 and an array of key openings 708 for accommodating keys of a keypad portion 710. A bottom housing portion 712 cooperates with top housing portion 702 and defines a magnetic card swipe slot 714.

Top housing portion 702 and bottom housing portion 712 together enclose a magnetic card reader assembly 720 and typically two PCBs 722, onto which are mounted electrical circuitry for operating the point of sale device 700.

Turning now to FIGS. 8A-9B, it is seen that the magnetic card reader assembly 720 includes a base member 730, preferably injection molded of plastic and including a screen support portion 732 defining a screen support surface 734 and, extending generally perpendicular thereto, a magnetic stripe reader head support portion 736. Magnetic stripe reader head support portion 736 includes an aperture 738 through which extends a magnetic stripe reader head 740, which may be of conventional construction and which is resiliently mounted onto magnetic stripe reader head support portion 736 by means of a spring support 742, ends of which are mounted onto magnetic stripe reader head support portion 736. A flexible connector 744 is coupled at one end 746 thereof to the magnetic stripe reader head 740 and at opposite end 747 thereof to a data connector 748.

A bottom facing edge 749 of magnetic stripe reader head support portion 736 defines a mounting surface for an elongate magnetic card edge engagement surface defining electrically conductive strip 750, preferably die cast of a zinc alloy, which extends transversely outwardly towards bottom housing portion 712 and thus preferably defines a floor of magnetic card swipe slot 714 with which floor the edge of a magnetic card (not shown) is in engagement as it is swiped through slot 714.

Strip 750 is operative to provide electrostatic discharge from a magnetic card, such as a metal card, a metal coated card or a card having an electrically conductive bottom edge, swiped therealong in either direction and in engagement therewith to ground, preferably via a ground connection portion 752 thereof, which is connected to a grounded terminal 754 formed on one of PCBs 722, typically via an electrical connector, such as a wire 755. The electrical discharge of the card occurs at least prior to engagement of the card with the magnetic strip reader head 740.

Grounded terminal 754 is preferably coupled to ground via electrical circuitry on PCB 722. Strip 750 is preferably secured to bottom facing edge 749 of magnetic stripe reader head support portion 736 by means of a pair of screws 756 and 757, which threadably engage respective suitably apertured bosses 758 and 759. Precise positioning of strip 750 onto bottom facing edge 749 is preferably enhanced by the provision of locator protrusions 760 on bottom facing edge 749, which engage corresponding apertures 761 on strip 750.

It will be appreciated by persons skilled in the art that the present invention is not limited by what has been particularly claimed and includes both combinations and subcombinations of features described and shown hereinabove as well as modifications thereof which are not in the prior art.

1. A slidable magnetic card reader particularly suitable for magnetic payment cards having at least one longitudinal edge surface, said card reader comprising:
a magnetic card reading head operative to provide a data output in response to sliding thereby of a magnetic payment card bearing readable magnetically encoded data; and
a magnetic payment card sliding track defining assembly including an elongate magnetic payment card edge engagement surface arranged for sliding engagement with a longitudinal edge surface of a magnetic payment card, said elongate magnetic payment card edge engagement surface extending at least to a location generally underlying said magnetic card reading head,
at least a portion of said elongate magnetic payment card edge engagement surface being electrically conductive and being coupled to electrical ground.

2. A slidable magnetic card reader according to claim 1 and wherein:
said elongate magnetic payment card edge engagement surface extends to two opposite sides of said location underlying said magnetic card reading head; and
at least a portion of said elongate magnetic payment card edge engagement surface on each of said two opposite sides of said location underlying said magnetic card reading head is electrically conductive and is coupled to electrical ground.

3. A slidable magnetic card reader according to claim 1 and wherein said elongate magnetic payment card edge engagement surface is electrically conductive substantially along its entire length.

4. A slidable magnetic card reader according to claim 1 and wherein said magnetic payment card sliding track defining assembly is electrically conductive.

5. A slidable magnetic card reader according to claim 1 and wherein said elongate magnetic payment card edge engagement surface comprises an electrically conductive strip.

6. A slidable magnetic card reader according to claim 5 and wherein said electrically conductive strip is die cut from a metal sheet.

7. A slidable magnetic card reader according to claim 5 and wherein said electrically conductive strip is die cast.

8. A slidable magnetic card reader according to claim 1 and wherein:
said elongate magnetic payment card edge engagement surface comprises an electrically non-conductive strip including at least two cutouts; and
an electrically conductive strip including at least two protrusions which resiliently extend through said at least two cutouts.
